(19) United States
(12) Patent Application Publication
(10) Pub. No.: US 2026/0164093 A1
(43) Pub. Date: Jun. 11, 2026

(54) MEDIA CONTENT PROCESSING

(71) Applicant: Lemon Inc., Grand Cayman (KY)

(72) Inventors: Bo LIU, Los Angeles, CA (US); Chongyang MA, Culver City, CA (US); Haibin HUANG, Los Angeles, CA (US); Yiding YANG, Los Angeles, CA (US); Yunzhu LI, Los Angeles, CA (US)

(21) Appl. No.: 19/412,551

(22) Filed: Dec. 8, 2025

(30) Foreign Application Priority Data
Dec. 9, 2024 (CN) 202411802996.8

(51) Int. Cl. H04N 21/80; G06N 20/00

(52) U.S. Cl. CPC H04N 21/80; G06N 20/00

(57) ABSTRACT

Embodiments of the disclosure relate to a method, a device, an electronic device and a storage medium for processing media content. The method includes: obtaining first media content; applying a first effect to the first media content by a first model to generate second media content; and providing the second media content, wherein the first model is trained by: training a pre-trained model associated with the first effect with a first sample set to determine a reference model; constructing a second sample set based on processing results for a plurality of sample images from the reference model; and training the first model with the second sample set.

### CROSS-REFERENCE

This application claims the benefit of Chinese Patent Application No. 202411802996.8 filed on Dec. 9, 2024, entitled “METHOD, APPARATUS, DEVICE, AND STORAGE MEDIUM FOR PROCESSING MEDIA CONTENT”, which is hereby incorporated by reference in its entirety.

### FIELD

Example embodiments of the present disclosure generally relate to the field of computers, and in particular, to media content processing.

### BACKGROUND

With the development of computer technologies, terminal devices such as mobile phones possess a capability of processing media content in real time based on artificial intelligence technology.

However, due to the limitation of the computing capability of a terminal device, the terminal device may take a long time to process media content, which affects the user experience.

### SUMMARY

In a first aspect of the present disclosure, a method for processing media content is provided. The method comprises: obtaining first media content; applying a first effect to the first media content by a first model to generate second media content; and providing the second media content, wherein the first model is trained by: training a pre-trained model associated with the first effect with a first sample set to determine a reference model; constructing a second sample set based on processing results for a plurality of sample images from the reference model; and training the first model with the second sample set.

In a second aspect of the present disclosure, an apparatus for processing media content is provided. The apparatus comprises: an obtaining module configured to obtain first media content; a processing module configured to apply a first effect to the first media content by a first model to generate second media content; and a providing module configured to provide the second media content, wherein the first model is trained by: training a pre-trained model associated with the first effect with a first sample set to determine a reference model; constructing a second sample set based on processing results for a plurality of sample images from the reference model; and training the first model with the second sample set.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium has a computer program stored thereon, and the computer program is executable by a processor to implement the method of the first aspect.

It should be understood that the content described in this Summary section is not intended to limit the key features or essential features of the embodiments of the present disclosure, nor is it intended to limit the scope of the present disclosure. Other features of the present disclosure will become readily understood from the following description.

### BRIEF DESCRIPTION OF DRAWINGS

Through the following detailed description with reference to the accompanying drawings, the above and other objectives, features, and advantages of example embodiments of the present disclosure will become more apparent. In the drawings, the same or similar reference numerals refer to the same or similar elements, where:

FIG. 1 illustrates a schematic diagram of an example environment in which embodiments according to the present disclosure may be implemented;

FIG. 2 illustrates a flowchart of an example process of processing media content according to some embodiments of the present disclosure;

FIGS. 3A-3E illustrate example interfaces according to some embodiments of the present disclosure;

FIG. 4 illustrates a flow block diagram of an example process of training a first model according to some embodiments of the present disclosure;

FIG. 5 illustrates a flowchart of an example process of training a first model according to some embodiments of the present disclosure;

FIG. 6 illustrates a flowchart of an example process of constructing a second sample set according to some embodiments of the present disclosure;

FIG. 7 illustrates a schematic diagram of an example process of adjusting a first image according to some embodiments of the present disclosure;

FIG. 8 illustrates a schematic structural block diagram of an example apparatus for processing media content according to some embodiments of the present disclosure; and

FIG. 9 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are illustrated in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to be open-ended, that is, “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, obtaining and/or use of data, and the like. These aspects all follow the corresponding laws and regulations and relevant provisions. In the embodiments of the present disclosure, collection, obtaining, handling, processing, forwarding, use, and the like of all data are performed on the basis that the user knows and confirms. Accordingly, when implementing the embodiments of the present disclosure, the types of the data or information that may be involved, the scope of use, the usage scenario, and the like should be notified to the user and the authorization of the user is obtained in an appropriate manner according to the relevant laws and regulations. The specific methods for notification and/or authorization manner may vary according to actual situations and application scenarios, and the scope of the present disclosure is not limited in this respect.

In the present specification and solutions in the embodiments, if personal information processing is involved, processing may be performed on the basis of legitimacy (e.g., obtaining the consent of a personal information subject, or as necessary for the performance of a contract), and processing is only within a scope specified or agreed range. The user's refusal to allow processing of personal information not necessary for the basic functions, does not affect the use of the basic function by the user.

As mentioned above, the terminal device usually processes the media content by using an artificial intelligence model that has the capability of processing media content. However, given the relatively recent deployment of such models in real-world scenarios, substantial optimization potential remains unexplored, including but not limited to the learning capability of the model, the response speed of the model, and the like. Once the model is optimized, the time consumed for processing the media content will be correspondingly shortened, so that the use experience of the user can be improved.

Embodiments of the present disclosure provide a solution for processing media content. The solution comprises: obtaining first media content; applying a first effect to the first media content by a first model to generate second media content; and providing the second media content, wherein the first model is trained by: training a pre-trained model associated with the first effect with a first sample set to determine a reference model; constructing a second sample set based on processing results for a plurality of sample images from the reference model; and training the first model with the second sample set.

According to the embodiments of the present disclosure, the second sample set is constructed through training the reference model by using the pre-trained model associated with the first effect and the second sample set is used to train the first model. The embodiments of the present disclosure can shorten the time required for training the first model, improve the training efficiency of the first model, and improve the processing quality of the model.

Various example implementations of this solution are described in detail below with reference to the accompanying drawings.

### Example Environment

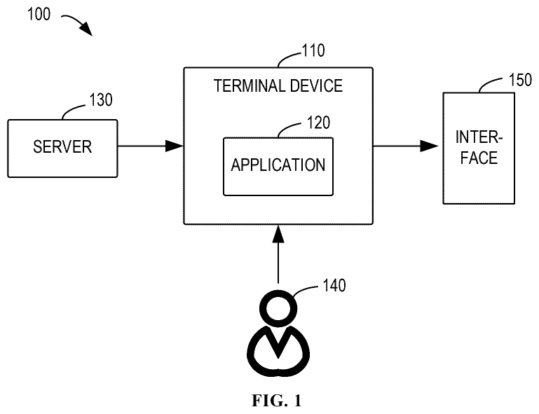

FIG. 1 illustrates a schematic diagram of an example environment 100 in which embodiments of the present disclosure can be implemented. As shown in FIG. 1, the example environment 100 may include a terminal device 110.

In this example environment 100, the terminal device 110 may run an application 120 that supports processing media content. The application 120 may be any suitable type of application for processing media content, examples of which may include, but are not limited to, an image processing application, a video processing application, or other suitable applications. The user 140 may interact with the application 120 via the terminal device 110 and/or its attachment device.

In the environment 100 of FIG. 1, if the application 120 is in an active state, the terminal device 110 may present, through the application 120, an interface 150 for supporting processing of media content.

In some embodiments, the terminal device 110 communicates with server 130 to enable provisioning of services to application 120. The terminal device 110 may be any type of mobile terminals, fixed terminals, or portable terminals, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a game device, or any combination thereof, including accessories and peripherals of these devices, or any combination thereof. In some embodiments, the terminal device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide a background service for an application 120 in the terminal device 110 that supports processing media content.

A communication connection may be established between the server 130 and the terminal device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the terminal device 110 may implement signaling interaction through a communication connection between the server 130 and the terminal device 110.

It should be understood that the structures and functions of the various elements in the environment 100 are described for example purposes only and do not imply any limitation to the scope of the present disclosure.

Some example embodiments of the present disclosure will be described below with continued reference to the accompanying drawings.

### Example Processes

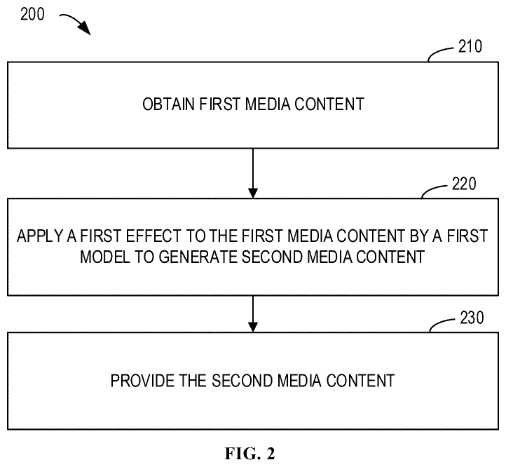

FIG. 2 illustrates a flowchart of an example process 200 of processing media content according to some embodiments of the present disclosure. The process 200 may be implemented at terminal device 110. The process 200 is described below with reference to FIG. 1.

As shown in FIG. 2, at block 210, the terminal device 110 obtains the first media content.

In some embodiments, the first media content may be media data obtained by the terminal device 110 from the user 140. The first media content may be presented in the form of an image, a video, or the like. As an example, the first media content may be transmitted to the terminal device 110 through photographing, wired/wireless transmission, or the like.

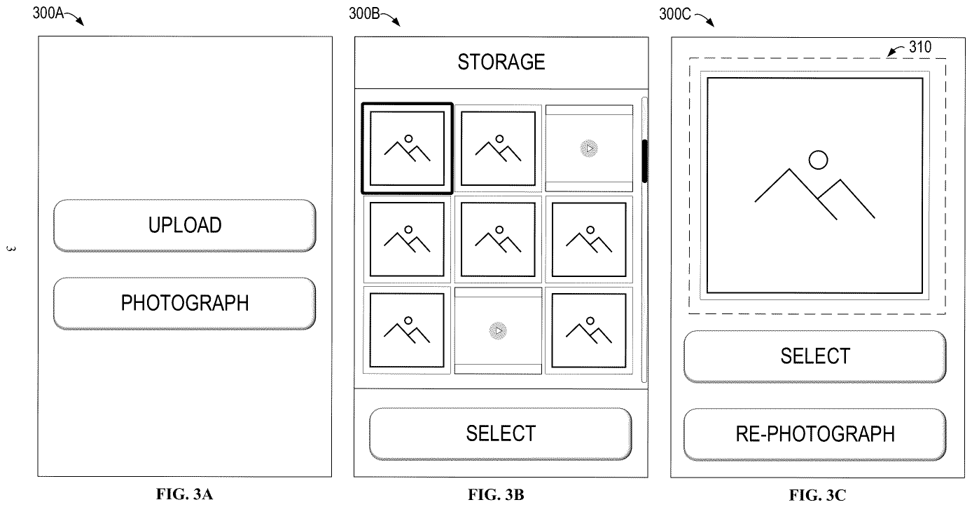

In some embodiments, as shown in FIG. 3A, the terminal device 110 may present an operation interface 300A configured to input the first media content. The operation interface 300A may include, but is not limited to, buttons with text “upload” and “photograph”.

When the terminal device 110 receives the operation information of the user on the “upload” button, the terminal device 110 may display the interface 300B, as shown in FIG. 3B. The interface 300B includes locally stored data, such as a local album. In the interface 300B, a button for a user to select an image is also provisioned to enable the terminal device 110 to upload the selected image.

When the terminal device 110 receives the operation information of the user on the “photograph” button, the terminal device 110 invokes the camera function and displays a corresponding interface. As shown in FIG. 3C, when the terminal device 110 obtains the shooting result, the terminal device 110 may present the shooting result through the interface 300C. As an example, the interface 300C may include, but is not limited to, an image preview area 310 indicating a shooting result, a button with text “select”, and a button with text “re-photograph”, so that the terminal device 110 can acquire an image obtained by photographing.

In some embodiments, as shown in FIG. 3D, after the terminal device 110 obtains the image selected by the user, the interface 300D may be displayed. As an example, the interface 300D may be provisioned with an image preview area 310 for a user to preview the selected image. In addition, the interface 300D may be further provisioned with a “generate” control indicating triggering the first model to apply a corresponding effect, and may be provisioned with a button for going back to the step of selecting image.

At block 220, the terminal device 110 applies a first effect to the first media content by a first model to generate second media content.

In some embodiments, the second media content is media content formed after the first effect is applied to the first media content. Similar to the presentation form of the first media content, the second media content may be in the form of an image form, a video or the like.

In some embodiments, there may be a plurality of categories of the first model according to the category of the media content to be processed and the category of the first effect, examples of which may include, but are not limited to, a model that can process the portrait image, a model that can process the face image, a model that can process a video, and the like.

At block 230, the terminal device 110 provides the second media content.

In some embodiments, as shown in FIG. 3E, after the terminal device 110 generates the second media content based on the first media content, the terminal device 110 may display, through the interface 300E, information related to the second media content to provide the second media content. As an example, the information related to the second media content may be at least one of: a preview image of the second media content or a download link of the second media content.

It should be understood that the media content generation interfaces shown in FIG. 3A to FIG. 3E are merely examples, and other suitable interfaces may be used to generate and provide the second media content. Individual graphical elements in the interface may have different arrangements and different visual representations, one or more of which may be omitted or replaced, and one or more other elements may also be present. Embodiments of the present disclosure are not limited in this respect.

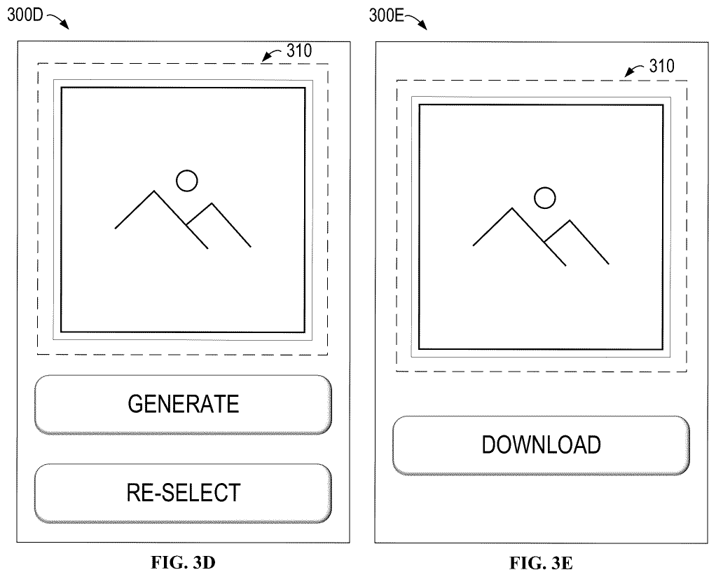

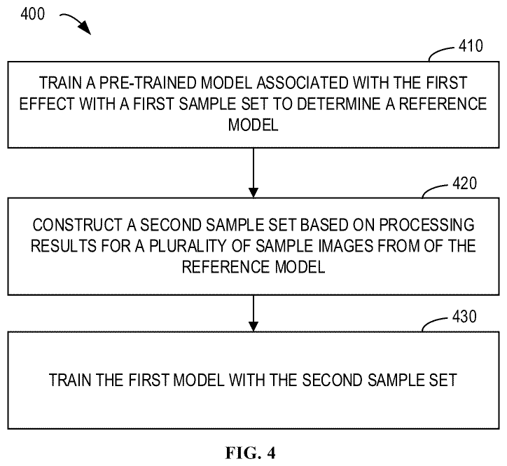

The specific training process of the first model will be further described below with reference to FIG. 4 and FIG. 5. FIG. 4 is a flow block diagram of an example process 400 for training a first model according to some embodiments of the present disclosure. FIG. 5 illustrates a flowchart of an example process 500 of training a first model according to some embodiments of the present disclosure. It should be understood that the process 400 and/or the process 500 may be performed by an appropriate electronic device, such as server 130. The process 600 will be described below with server 130 as an example.

As shown in FIG. 4, at block 410, the server 130 may train a pre-trained model associated with the first effect with a first sample set to determine a reference model.

As shown in FIG. 5, the first sample set 505 may include a sample pair associated with the first effect. Each sample pair may include, for example, an initial image and an image to which the first effect was applied. In some embodiments, in order to improve the training efficiency, the server 130 may determine, from a plurality of pre-trained models associated with different effects, a first pre-trained model 515 corresponding to the first effect.

In some embodiments, the first pre-trained model 515 may include a machine learning model associated with the first effect, examples of which may include, but are not limited to: Generative Adversarial Networks (GAN). Taking cosmetic effect as an example, different cosmetic effects may be associated with different pre-trained GAN models.

In some embodiments, the processing effect achieved by the first pre-trained model 515 and the first effect may belong to a same category. By training the first pre-trained model 515 with the first sample set 505, the time for training and obtaining the first pre-trained model 515 by using the first sample set 505 may be saved. For example, the first effect is a cosmetic effect A, and the processing effect achieved by the first pre-trained model 515 may be another cosmetic effect B. As an example, the server 130 may select, from a plurality of models that achieve effects of the same category, a model whose processing effect is close to the first effect, so as to serve as the first pre-trained model 515. Embodiments of the present disclosure may reduce the training cost of the model by selecting the first pre-trained model 515 associated with the effect, and improve the training efficiency of the model.

Additionally, when training the first pre-trained model 515 based on the first sample set 505, the server 130 may determine a training template 510 associated with the first pre-trained model 515 to further shorten the training duration. In some examples, training template 510 may be a combination of a plurality of hyperparameters. By combining with different training templates 510, embodiments of the present disclosure can effectively reduce the debugging process in model training and reduce the training cost of the model.

In this way, the server 130 may train the first pre-trained model 515 by using the first sample set 505 to obtain the reference model 525.

With continued reference to FIG. 2, at block 420, the server 130 may construct a second sample set 545 based on processing results of the reference model 525 for a plurality of sample images 520.

In some embodiments, the sample images 520 may be a still image or a video image. In some scenarios, the plurality of sample images 520 may also include both real and composite images. By using a mixture of the real and composite images, embodiments of the present disclosure can improve the processing effect of the model.

In some embodiments, the second sample set 545 may include a plurality of sample images 520, and processing results of the reference model 525 for each sample image. Each sample image 520 and processing results of the reference model 525 for the sample image 520 form a set of paired data.

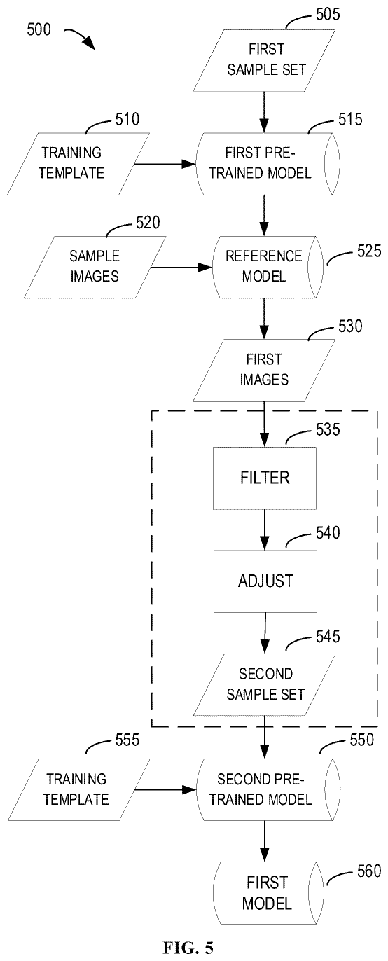

The specific process of constructing the second sample set 545 will be further described below with reference to FIG. 6. FIG. 6 illustrates a flowchart of an example process 600 of constructing a second sample set 545 according to some embodiments of the present disclosure.

Referring to FIG. 6, at block 610, the server 130 processes the plurality of sample images 520 by the reference model 525, to generate a plurality of first images 530 corresponding to the plurality of sample images 520.

In some embodiments, the first image 530 is an image result obtained after the sample image 520 is processed by the reference model 525. A type of the first image 530 is consistent with the type of the sample image 520. For example, the plurality of sample images 520 are all portrait images, and the corresponding plurality of first images 530 are all portrait images.

At block 620, the server 130 may construct a second sample set 545 based on the plurality of first images 530.

In some embodiments, as shown in FIG. 5, the server 130 may further filter 535 and/or adjust 540 the plurality of first images 530 to obtain a second sample set 545 of higher quality.

In some embodiments, the first image 530 and the sample image 520 corresponding thereto may each include a predetermined object. The predetermined object may be an object to which the first effect is applied, and an example thereof may be a person or an animal. By way of example, when the processing effect of the reference model 525 is applied to the predetermined object, this processing effect may change the style of the at least one feature point of the predetermined object. However, in practice, the processing effect of the reference model 525 may also change at least one feature point of the predetermined object. For example, the processing effect of the reference model 525 is a cosmetic effect. When the sample image 520 containing a portrait is processed with the reference model 525, the cosmetic effect changes the style of the eyelashes and eyebrows, and the position of the eyebrows. The portrait in the sample image 520 is the predetermined object. Each of the eyelashes and eyebrows is a feature point of the predetermined object. The cosmetic effect changes the position of the eyebrow, which is equivalent to changing the feature point of the predetermined object. Therefore, at 535, the server 130 may further obtain the plurality of second images by filtering out at least one image not satisfying a predetermined condition from the plurality of first images 530. Further, the server 130 may also construct the second sample set 545 based on the plurality of second images and corresponding sample images 520. In this way, embodiments of the present disclosure may improve the sample quality of the second sample set 545.

Specifically, the server 130 may, for example, detect, in each first image 530, a set of feature points associated with a predetermined object. Furthermore, the server 130 may filter out the at least one image, that does not meet the predetermined condition, from the plurality of first images 530 based on a plurality of sets of feature points.

In some embodiments, the predetermined condition may be related to the number of the set of feature points and/or a position relationship of the set of feature points, so as to filter out an image not suitable for applying the first effect. As an example, the server 130 may filter out, from the plurality of first images 530, one or more images whose number of feature points is less than the threshold and/or position relationship does not satisfy the predetermined condition.

By filtering the first image 530, the server 130 may obtain a plurality of second images. The server 130 may further pair the plurality of second images with the corresponding sample images 520 to construct the second sample set 545.

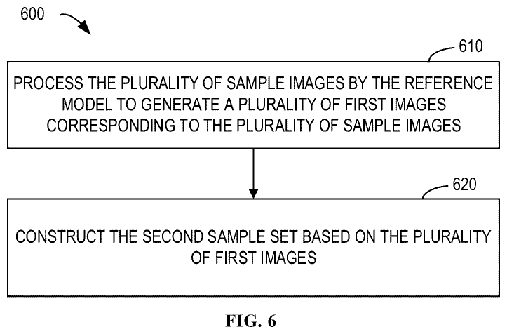

Referring to FIG. 7, in some embodiments, when the processing effect of the reference model 525 is applied to the sample image 520, the processing effect may change a predetermined application range 710 of the first effect. In practice, however, the processing effect of the reference model 525 may also change other regions that are different from the predetermined application range 710. For example, the processing effect of the reference model 525 is a cosmetic effect. When the sample image 520 containing a portrait is processed with the reference model 525, the cosmetic effect is that a filter is applied to the face region, and the colors of arms and legs of the person are changed. The predetermined application range 710 of the cosmetic effect is the face region. The cosmetic effect changes the color of the person's arms and legs, which is equivalent to changing other regions different from the predetermined application range 710. Therefore, a set of first image regions 720 in the plurality of first images 530 that is independent of the first effect may be determined based on the predetermined application range 710 of the first effect. The set of first image regions 720 in the plurality of first images 530 is then adjusted based on the plurality of sample images 520.

In some embodiments, the first image region 720 in the first image 530 that is independent of the first effect may include a region where an application range of the effect in the first image 530 exceeds the predetermined application range 710. As an example, there may be a plurality of first image regions 720 in the first image 530. For this case, the plurality of first image regions 720 may be referred to as a set of first image regions 720.

In some embodiments, the server 130 may replace a set of first image regions 720 in the first image 530 based on the sample image 520. Alternatively or additionally, the server 130 may also, for example, adjust the attribute information of the set of first image regions 720 based on the sample image 520.

In some embodiments, the server 130 may determine a set of second image regions 730 on a sample image 520 associated with the first image 530, and may further replace the set of first image regions 720 with the set of second image regions 730.

As shown in FIG. 7, a set of second image regions 730 may be associated with a set of first image regions 720. As an example, a position of the set of second image regions 730 on the sample image 520 is consistent with a position of the set of first image regions 720 on the first image 530. By replacing the set of first image regions 720 with the set of second image regions 730, embodiments of the present disclosure may further improve the processing quality of the model.

In some embodiments, the server 130 may further determine a set of third image regions 740 on the sample image 520 associated with the first image 530, and may further adjust the attribute information of the set of first image regions 720 based on the attribute information of the set of third image regions 740.

Continuing with the example of FIG. 7, a set of third image regions 740 is associated with a set of first image regions 720. As an example, a position of the set of third image regions 740 on the sample image 520 is consistent with a position of the set of first image regions 720 on the first image 530. In some embodiments, an attribute information of an image region may indicate a feature of the image region, e.g., a color, a size, or the like.

In some embodiments, the server 130 may, for example, adjust the attribute information of the set of first image regions 720 to be consistent with the attribute information of the set of third image regions 740.

Two adjustment means are described below with reference to a specific example. The plurality of sample images 520 are portrait images, and the processing effect of the reference model 525 is the cosmetic effect x. The predetermined application range 710 of the cosmetic effect x is the face portion in the image. A region in the first image 530 where the cosmetic effect is generated is a face portion, an arm portion, and a background of the first image. That is, the arm portion and the background of the first image 530 are a set of first image regions 720. After being processed by reference model 525, the color a of the arm portion becomes color b and background A becomes background B. As an example, the color may be attribute information of a region where the arm portion is located. After further adjustment, the color b of the arm portion in the first image 530 becomes color a, and the background B changes to background A. The color b of the arm portion becoming color a is achieved by adjusting the attribute information of the first image region 720 based on the attribute information of the third image region 740 in the sample image 520. The background B becoming the background A is achieved by replacing the second image region 730 with the first image region 720.

With continued reference to FIG. 5, the server 130 may obtain the plurality of second images by adjusting the plurality of first images 530. Further, the server 130 may pair the plurality of second images with corresponding sample images 520 to construct the second sample set 545.

At block 630, the server 130 trains the first model 560 with the second sample set 545.

In some embodiments, similar to the training process of the reference model 525, the server 130 may train the second pre-trained model 550 with the second sample set 545 to obtain the first model 560.

As an example, the second pre-trained model 550 may include a machine learning model associated with the first effect, examples of which may include, but are not limited to: Generative Adversarial Networks (GAN). Taking cosmetic effect as an example, different cosmetic effects may be associated with different pre-trained GAN models.

In some embodiments, the processing effect achieved by the second pre-trained model 550 and the first effect may belong to a same category. By training the second pre-trained model 550 with the second sample set 545, the time for training and obtaining the second pre-trained model 550 by using the second sample set 545 may be saved. For example, the first effect is a cosmetic effect A, and the processing effect achieved by the second pre-trained model 550 may be another cosmetic effect B. As an example, the server 130 may select, from a plurality of models that achieve effects of the same category, a model whose processing effect is close to the first effect, so as to serve as the second pre-trained model 550. Embodiments of the present disclosure may reduce the training cost of the model by selecting the second pre-trained model 550 associated with the effect, and improve the training efficiency of the model.

Additionally, when training the second pre-trained model 550 based on the second sample set 545, the server 130 may determine a training template 555 associated with the second pre-trained model 550 to further shorten the training duration. In some examples, training template 555 may be a combination of a plurality of hyperparameters. By combining with different training templates 555, embodiments of the present disclosure can effectively reduce the debugging process in model training and reduce the training cost of the model.

In this way, the server 130 may train the second pre-trained model 550 by using the second sample set 545 to obtain the reference model 525.

Based on the process described above, in embodiments of the present disclosure, the second sample set 545 is constructed through training the reference model 525 by using the first pre-trained model 515 associated with the first effect and the second sample set 545 is used to train the first model. The embodiments of the present disclosure can shorten the time required for training the first model 560, so that the efficiency of training the first model 560 is improved. In addition, the reference model 525 is trained by using the training template 540 matched with the first pre-trained model 515 and the filtering 545 and the adjusting 540 are performed on the first image 530, thereby the sample quality is further improved, and the processing quality of the first model is improved.

### Example Apparatus and Device

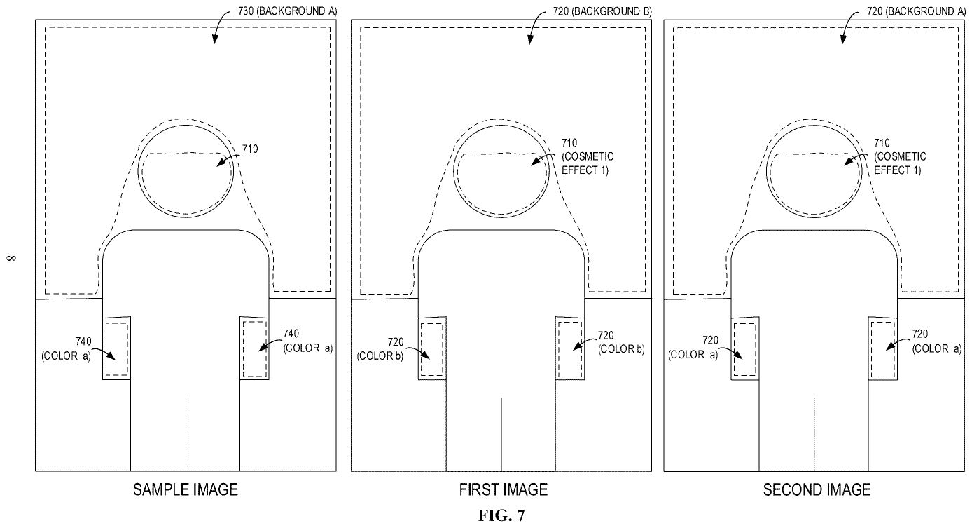

Embodiments of the present disclosure also provide a corresponding apparatus for implementing the above method or process. FIG. 8 illustrates a schematic structural block diagram of an example apparatus 800 for processing media content according to some embodiments of the present disclosure. The apparatus 800 may be implemented as or included in the terminal device 110. The various modules/components in the apparatus 800 may be implemented with hardware, software, firmware, or any combination thereof.

As shown in FIG. 8, the apparatus 800 includes: an obtaining module 810 configured to obtain first media content; a processing module 820 configured to apply a first effect to the first media content by a first model to generate second media content; and a providing module 830 configured to provide the second media content, wherein the first model is trained by: training a pre-trained model associated with the first effect with a first sample set to determine a reference model; constructing a second sample set based on processing results for a plurality of sample images from the reference model; and training the first model with the second sample set.

In some embodiments, the plurality of sample images includes a real image and a composite image.

In some embodiments, constructing the second sample set based on the processing results of the reference model for the plurality of sample images comprises: processing the plurality of sample images by the reference model to generate a plurality of first images corresponding to the plurality of sample images; and constructing the second sample set based on the plurality of first images.

In some embodiments, constructing the second sample set based on the plurality of first images comprises: filtering out at least one image not satisfying a predetermined condition from the plurality of first images to obtain a plurality of second images; and constructing the second sample set based on the plurality of second images and corresponding sample images.

In some embodiments, filtering out the at least one image not satisfying the predetermined condition from the plurality of first images comprises: detecting, in each of the plurality of first images, a set of feature points associated with a predetermined object; and filtering out the at least one image not satisfying the predetermined condition from the plurality of first images based on a plurality of sets of the feature points, the predetermined condition being related to a number of the set of feature points and/or a position relationship of the set of feature points.

In some embodiments, constructing the second sample set based on the plurality of first images comprises: determining, based on a predetermined application range of the first effect, a set of first image regions in the plurality of first images that is independent of the first effect; adjusting the set of first image regions in the plurality of first images based on the plurality of sample images; and constructing the second sample set based on the adjusted plurality of first images.

In some embodiments, adjusting the set of first image regions in the plurality of first images based on the plurality of sample images comprises: determining a set of second image regions on a sample image associated with the first image, the set of second image regions being associated with the set of first image regions; and replacing the set of first image regions with the set of second image regions.

In some embodiments, adjusting the set of first image regions in the plurality of first images based on the plurality of sample images comprises: determining a set of third image regions on a sample image associated with the first image, the set of third image regions being associated with the set of first image regions; and adjusting attribute information of the set of first image regions based on attribute information of the set of third image regions.

In some embodiments, the pre-trained model is a first pre-trained model, and training the first model comprises: training a second pre-trained model associated with the first effect with the second sample set, to obtain the first model.

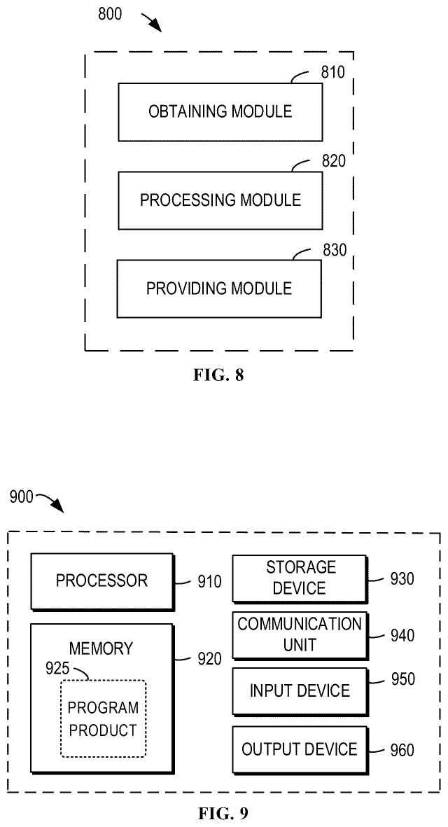

As shown in FIG. 9, the electronic device 900 is in the form of a general-purpose electronic device. Components of the electronic device 900 may include, but are not limited to, one or more processors or processing units 910, a memory 920, a storage device 930, one or more communication units 940, one or more input devices 950, and one or more output devices 960. The processing unit 910 may be an actual or virtual processor and capable of performing various processes according to programs stored in the memory 920. In multiprocessor systems, multiple processing units execute computer-executable instructions in parallel to improve parallel processing capabilities of the electronic device 900.

The electronic device 900 typically includes a plurality of computer storage media. Such media may be any available media accessible to the electronic device 900, including, but not limited to, volatile and non-volatile media, removable and non-removable media. The memory 920 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 930 may be a removable or non-removable medium and may include a machine-readable medium, such as a flash drive, a magnetic disk, or any other medium, which may be capable of storing information and/or data and may be accessed within the electronic device 900.

The electronic device 900 may further include additional removable/non-removable, volatile/non-volatile storage media. Although not shown in FIG. 9, a disk drive for reading from or writing to a removable, nonvolatile magnetic disk (e.g., a “floppy disk”) and an optical disk drive for reading from or writing to a removable, nonvolatile optical disk may be provided. In these cases, each drive may be connected to a bus (not shown) by one or more data media interfaces. The memory 920 may include a computer program product 925 having one or more program modules configured to perform various methods or actions of various embodiments of the present disclosure.

The communication unit 940 is configured to communicate with another electronic device through a communication medium. Additionally, the functionality of components of the electronic device 900 may be implemented in a single computing cluster or multiple computing machines which are capable of communication over a communication connection. Thus, the electronic device 900 may operate in a networked environment using logical connections with one or more other servers, network personal computers (PC), or another network node.

The input device 950 may be one or more input devices, such as a mouse, a keyboard, a trackball, or the like. The output device 960 may be one or more output devices, such as a display, a speaker, a printer, or the like. The electronic device 900 may also communicate with one or more external devices (not shown) through the communication unit 940 as needed, external devices such as storage devices, display devices, etc., communicate with one or more devices that enable a user to interact with the electronic device 900, or communicate with any device (e.g., a network card, a modem, etc.) that enables the electronic device 900 to communicate with one or more other electronic devices. Such communication may be performed via an input/output (I/O) interface (not shown).

According to example implementations of the present disclosure, there is provided a computer-readable storage medium having computer-executable instructions stored thereon, where the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by the processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium, these instructions cause the computer, programmable data processing apparatus, and/or other devices to function in a specific manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process, such that the instructions executed on a computer, other programmable data processing apparatus, or other apparatus implement the functions/acts specified in one or more blocks in the flowchart and/or block diagram.

The flowchart and block diagrams in the drawings show architecture, function, and operation of possible implementations of systems, methods, and computer program products according to various implementations of the present disclosure. In this regard, each block in the flowchart or block diagram may represent a module, a program segment, or a part of an instructions that includes one or more executable instructions for implementing the specified logical function. In some alternative implementations, the functions noted in the blocks may also occur in a different order than noted in the drawings. For example, two consecutive blocks may actually be performed substantially in parallel, which may sometimes be performed in the reverse order, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for processing media content, comprising:
obtaining first media content;
applying a first effect to the first media content by a first model to generate second media content; and
providing the second media content,
wherein the first model is trained by:
training a pre-trained model associated with the first effect with a first sample set to determine a reference model;
constructing a second sample set based on processing results for a plurality of sample images from the reference model; and
training the first model with the second sample set.

2. The method of claim 1, wherein the plurality of sample images comprises a real image and a composite image.

3. The method of claim 1, wherein constructing the second sample set based on the processing results of the reference model for the plurality of sample images comprises:
processing the plurality of sample images by the reference model to generate a plurality of first images corresponding to the plurality of sample images; and
constructing the second sample set based on the plurality of first images.

4. The method of claim 3, wherein constructing the second sample set based on the plurality of first images comprises:
filtering out at least one image not satisfying a predetermined condition from the plurality of first images to obtain a plurality of second images; and
constructing the second sample set based on the plurality of second images and corresponding sample images.

5. The method of claim 4, wherein filtering out the at least one image not satisfying the predetermined condition from the plurality of first images comprises:
detecting, in each of the plurality of first images, a set of feature points associated with a predetermined object; and
filtering out the at least one image not satisfying the predetermined condition from the plurality of first images based on a plurality of sets of the feature points, the predetermined condition being related to at least one of: a number of the set of feature points or a position relationship of the set of feature points.

6. The method of claim 3, wherein constructing the second sample set based on the plurality of first images comprises:
determining, based on a predetermined application range of the first effect, a set of first image regions in the plurality of first images that is independent of the first effect;
adjusting the set of first image regions in the plurality of first images based on the plurality of sample images; and
constructing the second sample set based on the adjusted plurality of first images.

7. The method of claim 6, wherein adjusting the set of first image regions in the plurality of first images based on the plurality of sample images comprises:
determining a set of second image regions on a sample image associated with the first image, the set of second image regions being associated with the set of first image regions; and
replacing the set of first image regions with the set of second image regions.

8. The method of claim 6, wherein adjusting the set of first image regions in the plurality of first images based on the plurality of sample images comprises:
determining a set of third image regions on a sample image associated with the first image, the set of third image regions being associated with the set of first image regions; and
adjusting attribute information of the set of first image regions based on attribute information of the set of third image regions.

9. The method of claim 1, wherein the pre-trained model is a first pre-trained model, and training the first model comprises:
training a second pre-trained model associated with the first effect with the second sample set, to obtain the first model.

10. An electronic device, comprising:
at least one processor; and
at least one memory coupled to the at least one processor and storing instructions for execution by the at least one processor, wherein the instructions, when executed by the at least one processor, cause the electronic device to perform acts comprising:
obtaining first media content;
applying a first effect to the first media content by a first model to generate second media content; and
providing the second media content,
wherein the first model is trained by:
training a pre-trained model associated with the first effect with a first sample set to determine a reference model;
constructing a second sample set based on processing results for a plurality of sample images from the reference model; and
training the first model with the second sample set.

11. The electronic device of claim 10, wherein the plurality of sample images comprises a real image and a composite image.

12. The electronic device of claim 10, wherein constructing the second sample set based on the processing results of the reference model for the plurality of sample images comprises:
processing the plurality of sample images by the reference model to generate a plurality of first images corresponding to the plurality of sample images; and
constructing the second sample set based on the plurality of first images.

13. The electronic device of claim 12, wherein constructing the second sample set based on the plurality of first images comprises:
filtering out at least one image not satisfying a predetermined condition from the plurality of first images to obtain a plurality of second images; and
constructing the second sample set based on the plurality of second images and corresponding sample images.

14. The electronic device of claim 13, wherein filtering out the at least one image not satisfying the predetermined condition from the plurality of first images comprises:
detecting, in each of the plurality of first images, a set of feature points associated with a predetermined object; and
filtering out the at least one image not satisfying the predetermined condition from the plurality of first images based on a plurality of sets of the feature points, the predetermined condition being related to at least one of: a number of the set of feature points or a position relationship of the set of feature points.

15. The electronic device of claim 12, wherein constructing the second sample set based on the plurality of first images comprises:
determining, based on a predetermined application range of the first effect, a set of first image regions in the plurality of first images that is independent of the first effect;
adjusting the set of first image regions in the plurality of first images based on the plurality of sample images; and
constructing the second sample set based on the adjusted plurality of first images.

16. The electronic device of claim 15, wherein adjusting the set of first image regions in the plurality of first images based on the plurality of sample images comprises:
determining a set of second image regions on a sample image associated with the first image, the set of second image regions being associated with the set of first image regions; and
replacing the set of first image regions with the set of second image regions.

17. The electronic device of claim 15, wherein adjusting the set of first image regions in the plurality of first images based on the plurality of sample images comprises:
determining a set of third image regions on a sample image associated with the first image, the set of third image regions being associated with the set of first image regions; and
adjusting attribute information of the set of first image regions based on attribute information of the set of third image regions.

18. The electronic device of claim 10, wherein the pre-trained model is a first pre-trained model, and training the first model comprises:
training a second pre-trained model associated with the first effect with the second sample set, to obtain the first model.

19. A non-transitory computer-readable storage medium having a computer program stored thereon, wherein the computer program is executable by a processor to perform acts comprising:
obtaining first media content;
applying a first effect to the first media content by a first model to generate second media content; and
providing the second media content,
wherein the first model is trained by:
training a pre-trained model associated with the first effect with a first sample set to determine a reference model;
constructing a second sample set based on processing results for a plurality of sample images from the reference model; and
training the first model with the second sample set.

20. The non-transitory computer-readable storage medium of claim 19, wherein the plurality of sample images comprises a real image and a composite image.
